(19) United States
(12) Patent Application Publication
(10) Pub. No.: US 2003/0086839 A1
(43) Pub. Date: May 8, 2003

(54) Catalytic reactors

(76) Inventor: Eugeny I. Rivin, West Bloomfield, MI (US)

Correspondence Address: EVGENY I RIVIN, 4227 FOX POINTE DRIVE, WEST BLOOMFIELD, MI, 48323

(21) Appl. No.: 10/278,383

(22) Filed: Oct. 23, 2002

Related U.S. Application Data
(60) Provisional application No. 60/334,750, filed on Oct. 31, 2001.

(51) Int. Cl. B01J 19/12; B01J 19/08

(52) U.S. Cl. 422/186.01

(57) ABSTRACT

It is suggested to subject the catalyst-supporting structure with attached to it catalyst to electromagnetic field generated inside the catalytic reactor by an induction coil or by microwave -generator, with the support structure being made from materials exhibiting a significantly lesser absorption of the electromagnetic energy than the catalyst material (or the catalyst carrier material) so that absorption by the catalyst or by catalyst carrier material of energy from the electromagnetic field results in fast heating of the catalyst to its working temperature without a significant heating of the catalyst support structure, thus with a small overall consumption of energy.

Priority for this application is requested to be Oct. 31, 2001 per Provisional Patent Application 60/334,750.

### FIELD OF THE INVENTION

The present invention relates to catalytic reactors such as ones employed in fuel cells, automotive catalytic converters, metal-air batteries, fuel reformers, etc.

### BACKGROUND OF THE INVENTION

Catalysts allow to enhance intensity of chemical reactions between the reacting substances, to reduce required temperatures and pressures in the reaction areas, to perform otherwise impossible reactions, etc. The representative examples of catalytic reactors are fuel cells, automotive catalytic converters, metal-air batteries, fuel reformers.

In many cases catalytic reactors are very expensive since they are using expensive materials as catalysts, such as platinum, ruthenium, etc.

In fuel cells the platinum catalysts should be used if the reactive area functions at low temperatures 20-100° C. If the reaction runs at high temperatures (e.g., fuel cells with solid electrolyte, up to t=500-1,000° C.), the same reaction of combining hydrogen and oxygen can be supported by an inexpensive nickel- or cobalt-based catalyst, (e.g., see J. Larminie, A. Dicks, “Fuel Cell Systems Explained”, John Wiley & Sons, 2001).

To be effective, the catalysts require large contact surfaces. A straightforward increase of contact surfaces results in unacceptable large sizes of the reactors and in a need for large amounts of the expensive catalytic materials. As a result, in many cases catalytic reactors employ supporting structures made of ceramics or other non-reactive heat-resistant material. These structures usually have a multiplicity of capillary passages and/or pores whose surfaces are embedded with numerous minute particles of the catalyst. This arrangement increases effective contact surface area while maintaining a reasonable size.

In some cases a catalytically supported reaction fully develops only gradually, after the reactor reaches a certain high temperature (“cold start”). For example, catalytic converters in cars do not function well until they reach steady-state high temperatures of ˜500-600° C., which usually requires 30-120 sec; as a consequence, emissions during the cold start are excessive. The fuel cells may require up to 150 sec for the cold start, see the above cited book. One approach for correcting this situation is to artificially preheat the whole catalytic reactor to its steady-state temperature before or during the cold start event, e.g. see U.S. Pat. No. 5,477,676 (1995) granted to D. Benson and T. Potter. Obviously, such an approach involves waste of a significant amount of energy and requires expensive powerful heaters, while still taking an undesirably long time or large amounts of a heat-retaining material.

This invention, as described and claimed below, is aimed for elimination of the above-quoted shortcomings of the catalytic reactors.

### SUMMARY OF THE INVENTION

It is suggested to improve performance characteristics of catalytic reactors by application of high frequency electromagnetic field to the reaction area.

It is also suggested to provide heating only of the catalyst and, in some cases, of parts of the catalyst-supporting structure, without wasting energy for heating the whole catalyst-supporting structure.

It is further suggested to use induction heating systems (e.g., induction coils) to achieve the required temperature of the catalyst, depending on the design of the catalytic reactor and the materials present in the reaction area.

It is additionally suggested to use microwave heating systems to achieve the required temperature of the catalyst, depending on the design of the catalytic reactor and the materials present in the reaction area.

It is also suggested to use carrier ferromagnetic particles in the catalytic reactors, these particles possessing the desired characteristics such as specified Curie point temperatures in order to achieve a precision specified temperature of the catalyst.

### BRIEF DESCRIPTION OF THE DRAWINGS

The present invention can best be understood with reference to the following detailed description and drawings, in which:

FIG. 1 is a cross section of a Prior Art typical catalytic reactor represented by a schematic of an automobile catalytic converter.

FIG. 2 is a longitudinal section of one embodiment of the proposed catalytic reactor with built-in an internal induction coil.

FIG. 3 is a longitudinal section of another embodiment of the proposed catalytic reactor with an outside-mounted induction coil.

FIG. 4 is a longitudinal section of yet another embodiment of the proposed catalytic reactor with an outside-mounted microwave generator.

### DETAILED DESCRIPTION OF THE PREFERRED EMBODIMENTS

While it would be appreciated by those skilled in the art that catalytic reactors may have various designs/embodiments, the present invention will be described on the example of a typical automotive catalytic converter with an understanding that the proposed techniques and concepts can be fully applied to other designs of catalytic reactors after appropriate and obvious design changes while using the described concepts.

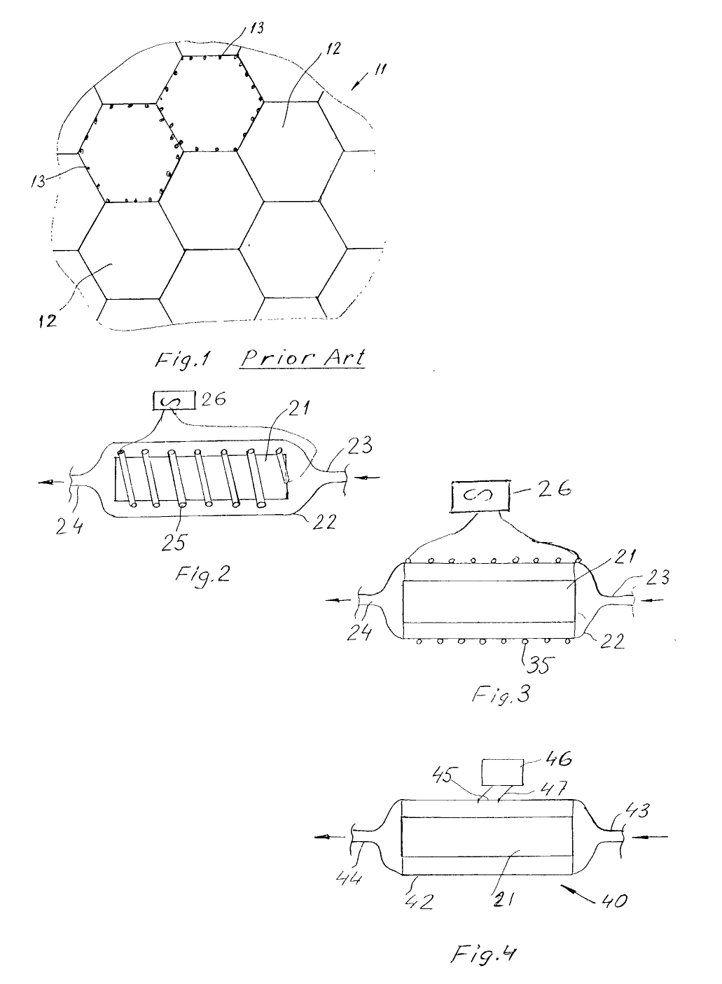

FIG. 1 (the Prior Art) represents a cross section of ceramic catalyst support structure 11 of a typical automotive catalytic converter. Ceramic structure 11 has a multiplicity of longitudinal passages/capillaries 12. Multiple minute particles 13 of the catalytic material (catalyst) are embedded into the surfaces of passages 12; only a few particles are shown in FIG. 1. The combination of the large number of passages 12 in support structure 11 and the large number of particles 13 in each passage results in a large effective surface of the catalyst combined with a relatively small amount of the expensive catalytic material by weight.

The catalytic conversion of the car engine exhaust gases occurs at temperatures in the range of 500-600° C. Due to lower exhaust temperatures at the cold start conditions and a significant time required for the ceramic structure to acquire the required steady-state temperature, the adequate conversion of the exhaust gases does not develop for 30-120 sec after the cold start had been initiated. The emitted un-converted exhaust during this time is a substantial contributor to the overall amount of the polluting chemicals emitted by automobiles.

FIG. 2 shows a longitudinal section of one embodiment of an automotive catalytic converter 20 per the instant invention. Here 21 is ceramic structure, similar or identical to the Prior Art structure in FIG. 1, with the capillary passages and the catalyst particles dispersed in the capillary passages and embedded into the exposed surfaces of the capillary passages. Housing 22 encloses ceramic structure 21. The exhaust gases enter housing 22 by inlet 23 and exit housing 22 by outlet 24, as illustrated by arrows. Ceramic structure 21 is surrounded by induction coil 25 which is energized from high frequency current generator 26.

If the catalyst is made from an electroconductive and/or ferromagnetic material, its particles can be easily and very quickly heated by inducing in them eddy currents generated by induction coil 25. In cases when the catalyst is used not in the highly dispersed state, its mass is still much smaller than that of the supporting structure, thus the energy and time required for its preheating to the required temperature are still much less than for preheating of the whole reactor. It is known that any electroconductive material is subjected to heating by eddy currents generated by an induction coil fed by a high frequency current, if it is located within the electromagnetic field generated by the induction coil. The heating intensity is increasing with increasing field intensity, and with increasing degree of electroconductivity of the material. The heating effect is especially strong for magnetic (ferromagnetic) materials below their Curie point temperature. After the Curie point temperature is exceeded, the ferromagnetic properties are lost and the heating intensity is significantly decreasing thus providing a possibility for a “self-control” of the heating intensity and temperature.

If the substrate onto which the catalyst particles are attached is not electroconductive (e.g., made from ceramic) then only a minute amount of energy is needed to quickly heat the electroconductive catalyst particles to the desired temperature. If the substrate is electroconductive but not ferromagnetic, while the catalyst is both (e.g., the nickel-based catalyst), then the catalyst would heat much faster than the substrate, with also a relatively small waste of energy. In many cases, special measures can be taken to reduce electroconductivity of the substrate and/or the supporting structure. The energy loss due to thermoconductivity to the surrounding catalyst-supporting structure is usually small due to small contact surfaces between the catalyst and the supporting structure and, often, due to low thermoconductivity of the substrate material (e.g., ceramic). Thus, a very limited source of the electromagnetic energy is required in many applications.

If housing 22 is made from a material with low electroconductivity, induction coil 35 can be placed outside housing 22 as illustrated in FIG. 3 showing another embodiment of the instant invention.

If the catalyst material is not adequately electroconductive and/or electromagnetic, or in other cases when it can be desirable by whatever reasons, the catalytic material can be attached to/coated on particles made from an electroconductive and/or ferromagnetic material (having a specified Curie point, if necessary) which are, in their turn, attached to the appropriate substrate in the reactive area. Such “piggy backing” may even enhance the intensity of the catalyst heating process.

Attachment of the catalytic material to ferromagnetic particles can be used for a precise control of the heating temperature if the ferromagnetic material with its Curie point corresponding to the desired temperature is selected. Ferromagnetic material can be quickly heated by the induced electricity until its Curie point is reached and the ferromagnetic properties are lost, thus quickly slowing down the heating process.

Heating only the catalyst, possibly with the associated carrier particles, answers the need for the effective reaction that takes place at the catalyst surface (thus the reacting media would also heat up as needed), without heating and thermally insulating the whole reactor. Thus, for high-temperature fuel cells, the nickel-based catalyst can be heated to the required high temperature during the start-up (after which the reaction zone is self-heated), and in the above automotive catalytic converter illustrated by FIGS. 2 and 3 the cold start emissions can be significantly reduced.

The automotive catalytic converters such as illustrated in FIGS. 1-3 provide for intensification of desired reactions between gases. The specific heat of the gases is relatively low and they are locally heated by the catalyst particles preheated by the exposure to the electromagnetic field created by the induction coil. However, some catalytically-assisted reactors have at least one reactant in a liquid state. For example, reactions in liquid-state fuel cells involve interaction between a gas (hydrogen or oxygen) and a liquid electrolyte. The liquid reactant has a much greater specific heat and thus cannot obtain enough thermal energy from the tiny catalyst particles or thin catalytic coatings. The induction coils, which usually operate in KHz-MHz frequency range of the electric current thus may not be very effective in heating the reacting liquids.

In such cases, another frequency range of the electromagnetic field can be beneficially used. The field frequency range can be “tuned” for the maximum efficiency in heating the desired reactants and/or catalysts, while not significantly influencing other materials, such as ones used in the supporting structures and housings.

The microwave frequency range (gigahertz or GHz) is specially attractive since the technology is widely used for many applications, such as microwave ovens (˜1.5 GHz) and thus has economic advantages of the magnetron generators being already in mass production.

FIG. 4 shows a catalytic converter 40 comprising ceramic catalyst-supporting structure 21 enclosed in housing 42. The exhaust gases enter the converter housing through inlet 43 and exit through outlet 44. This catalytic reactor is thermally assisted by microwave radiation transmitted through window 45 made from a microwave-transparent material, such as glass, ceramic, polymer, etc., from magnetron microwave generator 46. A significant advantage of the embodiment in FIG. 4 is a possibility of packaging the microwave generator remotely from the reactor and connecting it by waveguide 47.

Depending on the requirements, the electromagnetic field can be activated only for the cold start period or be continuously applied to the reactor.

In many cases, the same high frequency generator can be used for both ultrasonic vibration generation and for induction heating, thus further reducing costs. Application of ultrasonic vibration to catalytic reactors is described in another U.S. patent application by the same inventor and having the same filing date.

It is readily apparent that the components of catalytic reactors to which an electromagnetic field is applied disclosed herein may take a variety of configurations. Thus, the embodiments and exemplifications shown and described herein are meant for illustrative purposes only and are not intended to limit the scope of the present invention, the true scope of which is limited solely by the claims appended thereto.

1. A catalytic reactor for enhancing intensity of chemical reactions between reacting substances, comprising a catalyst support structure and a catalyst attached to said support structure and exposed to said reacting substances, wherein the catalyst is subjected to electromagnetic field generated by a source of electromagnetic radiation, and said support structure is made from materials exhibiting a significantly lesser absorption of the electromagnetic energy generated by said source than the catalyst material.

2. A catalytic reactor of claim 1 wherein said catalyst comprises finely dispersed particles.

3. A catalytic reactor of claim 1 wherein said catalyst is attached to a substrate surface, said substrate being attached to said support structure.

4. A catalytic reactor of claims 1 and 3 wherein said substrate is made from a material exhibiting a significantly lesser absorption of the electromagnetic energy generated by said source than the catalyst material.

5. A catalytic reactor of claim 1 wherein said source of electromagnetic radiation is embodied as an induction coil powered from an external generator of high frequency current.

6. A catalytic reactor of claims 1 and 5 wherein said induction coil is packaged inside the catalytic reactor.

7. A catalytic reactor of claims 1 and 5 wherein said induction coil is packaged outside the catalytic reactor

8. A catalytic reactor of claim 1 wherein said source of electromagnetic radiation is embodied as a microwave generator

9. A catalytic reactor of claims 1 and 8 wherein said microwave generator is connected to the catalytic reactor by a waveguide.

10. A catalytic reactor of claim 1 wherein said source is activated only for the cold start event of said catalytic reactor.

11. A catalytic reactor of claim 1 wherein said source is continuously operated during the operational time of said catalytic reactor.

12. A catalytic reactor of claim 1 wherein said external high frequency generator is also used for generating mechanical ultrasonic vibrations of the reacting medium.

13. A catalytic reactor of claim 1 wherein said catalyst is attached to electroconductive carrier particles which are in turn attached to said supporting structure.

14. A catalytic reactor of claims 1 and 5 wherein said catalyst is attached to ferromagnetic carrier particles which are in turn attached to said supporting structure.

15. A catalytic reactor of claims 1 and 14 wherein said ferromagnetic carrier particles have their Curie point temperature close to the specified catalyst temperature.
